(19) United States
(12) Patent Application Publication
(10) Pub. No.: US 2016/0232495 A1
(43) Pub. Date: Aug. 11, 2016

(54) Appointment Invitation Method and System

(71) Applicant: Education Planet Limited, Hong Kong (HK)

(72) Inventors: Pui Yee Au, Hong Kong (HK); Garrett Wong, Hong Kong (HK)

(73) Assignee: Education Planet Limited

(21) Appl. No.: 14/621,405

(22) Filed: Feb. 13, 2015

Related U.S. Application Data
(63) Continuation-in-part of application No. 14/617,943, filed on Feb. 10, 2015, now abandoned.

(51) Int. Cl. G06Q 10/10; H04L 12/58

(52) U.S. Cl. CPC G06Q 10/1095; H04L 51/046

(57) ABSTRACT

The present invention relates to an appointment invitation method comprising: sending via a messaging module an invitation message comprising a time information, as well as an optional attendee information and/or an optional location information, for an appointment from an inviter to at least one invitees; receiving via the messaging module one or more responses from the at least one invitees indicating an acknowledgement, acceptance, desirable amendment, or rejection to the appointment; and determining the appointment or negotiating/rescheduling the appointment based at least partly on the one or more responses received from the at least one invitees until the appointment is determined. The present invention enables a better utilization of time by transferring real time and more interactive communications for negotiating and determining various kinds of appointments between desired attendees while preventing disclosure of undesired personal particulars thereof.

### CROSS-REFERENCE TO RELATED APPLICATIONS

This application is a Continuation-In-Part application of U.S. application Ser. No. 14/617,943 filed on Feb. 10, 2015, the contents of which are hereby incorporated by reference.

### FIELD OF THE INVENTION

The present invention relates to a communications method and system, and more particularly to an appointment invitation method and system for initiating and establishing an appointment between at least two relevant attendees via a messaging module.

### DESCRIPTION OF RELATED ART

With the modern pace of lifestyle, finding time has turn into a difficult task as essentially everyone is exchanging time to achieve something they want, from skiing, lying on a resort, and spending time with spouse and friends, to holding business meeting are all done in the expense of time. As time is finite and equal upon everyone, making time efficient to us is critical. In addition, it is quite clear to many people that the most precious thing in life is time.

Presently, most appointments are made through telephonic, email and/or video communications between a plurality of attendees comprising at least one inviters and at least one invitees, wherein an invitation message comprising a time information, a location information and probably an attendee information for the appointment is made available to each of the attendees and such message or details of the appointment might be continuously revised and negotiated by all parties involved until the appointment is determined and accepted by the targeted/final attendees thereof. Nowadays, different calendar applications run on various platforms or devices, such as Microsoft Outlook, Google Calendar, iCal, or the like, are used for management of meetings or appointments, and all of such applications are substantially based on non-real-time, relatively time consuming, and less interactive email systems or services while being run on different devices capable of real-time communications, such as a smartphone, a tablet computer/computing device, a notebook/netbook, a desktop PC, or the like. It is thus desirable to have a real-time and relatively quick responding and more interactive appointment invitation method and system and/or calendar system to enable an even better use of time.

### SUMMARY OF THE INVENTION

An object of the present invention is to overcome at least partly the above defects in the prior art by providing an invitation method, system and application for relatively easy and fast negotiation and determination of appointment for better utilization of time.

Accordingly, one of the technical solutions of the present invention provided for the above object being an appointment invitation method, which comprises:

sending via a messaging module an invitation message comprising a time information indicating a target time and/or one or more preset target time alternatives for holding an appointment from an inviter to at least one invitees; receiving via the messaging module one or more responses indicating an acknowledgement, acceptance, desirable amendment, or rejection to the appointment from the at least one invitees; and
determining the appointment or negotiating/rescheduling the appointment based at least partly on the one or more responses received from the at least one invitees until the appointment is determined;
preferably, the invitation message might further comprise an attendee information and/or an location information being optional to the invitation message such that determination of the appointment is independent of either one or both.

Preferably, rescheduling the appointment further comprises responsive to the desirable amendment, sending one or more amended invitation message to and receiving one or more responses from the at least one invitees until the appointment is accepted by the inviter and at least one of the invitees and/or by at least two of the invitees.

According to one embodiment of the present invention, the invitation method further comprises updating native calendar systems of the messaging module by inserting the determined appointment thereinto.

According to another embodiment of the present invention, the invitation method further comprises exporting data for the determined appointment of the native calendar system into conventional calendar systems, such as MS Outlook Calendar Google Calendar, iCal, or the like.

According to still another embodiment of the present invention, the invitation method further comprises:

acquiring position information of the inviter and the at least one invitees; and
adjusting the time information based on the position information while transferring the message and the response.

According to yet still another embodiment of the present invention, the invitation method further comprises:

acquiring geographical and/or time zone position information of the inviter and the at least one invitees; and
adjusting the time information based on the geographical or time zone position information while transferring the message and the response.

According to yet still another embodiment, the attendee information might comprise an alias without indication of specific personal particulars of each of the inviter and at least one of the invitees to prevent establishment of a direct communication between the invitees.

Alternatively, the attendee information might comprise an alias without indication of specific personal particulars of each of at least two of the invitees to prevent establishment of an external direct communication therebetween.

According to another embodiment, the specific personal particulars might comprise a real name, an address, an ID number, an email address, a phone number, or any other specific data enabling establishment of an external direct communication therebetween.

According to another embodiment, determining the appointment further comprises determining whether the appointment is accepted by the inviter and at least one of the invitees and/or by at least two of the invitees based at least partly on the one or more responses.

According to still another embodiment, the invitation method of the present invention further comprises:

converting the invitation message into an invitation notice comprising a basic information for the appointment and a link for acquiring the messaging module; and
sending it via a messaging protocol from the inviter to the at least one invitees who had not acquired the messaging module. Preferably, the messaging protocol is at least one of SMS, MMS, or push notifications for delivering real-time communication.

According to another aspect of the present invention, there is provided an appointment invitation system comprising:

means for sending via a messaging module an invitation message comprising a time information, as well as an optional attendee information and/or an optional location information, for an appointment from an inviter to at least one invitees selected from a database;
means for receiving via the messaging module one or more responses from the at least one invitees indicating an acknowledgement, acceptance, desirable amendment, or rejection to the appointment; and
means for determining the appointment or negotiating/rescheduling the appointment based at least partly on the one or more responses received from the at least one invitees until the appointment is determined;
means for interchanging the time information based on geographical and/or time zone position information of the inviter and the at least one invitees while transferring the message and the response; and
means for enabling appointment negotiation via the messaging module but preventing establishment of an external direct communication between the invitees while rescheduling the appointment.

According to a further aspect of the present invention, there is provided a program embedded on a medium when executed by a computing device for causing the computing device to perform a processing for invitation of an appointment, the program comprising:

sending via a messaging module an invitation message comprising a time information, as well as an optional attendee information and/or an optional location information, for an appointment from an inviter to at least one invitees selected from a database;
receiving via the messaging module one or more responses from the at least one invitees indicating an acknowledgement, acceptance, desirable amendment, or rejection to the appointment; and
determining the appointment or negotiating/rescheduling the appointment based at least partly on the one or more responses received from the at least one invitees until the appointment is determined; and
wherein the program further comprising interchanging the time information based on geographical and/or time zone position information of the inviter and the at least one invitees while transferring the message and the response; and enabling appointment negotiation via the messaging module but preventing establishment of an external direct communication between the invitees while rescheduling the appointment.

### BRIEF DESCRIPTION OF THE DRAWINGS

The further objects, features, characteristics and advantages of the present invention will be illustrated below in more details by way of example with reference to the accompany drawings.

FIG. 1 is a block diagram showing an invitation method according to one embodiment of the present invention.

### DETAILED DESCRIPTION OF PREFERRED EMBODIMENTS

In order to enable a better use of time, the present invention provides various invitation methods and systems for initiating and establishing an appointment between at least two attendees thereof.

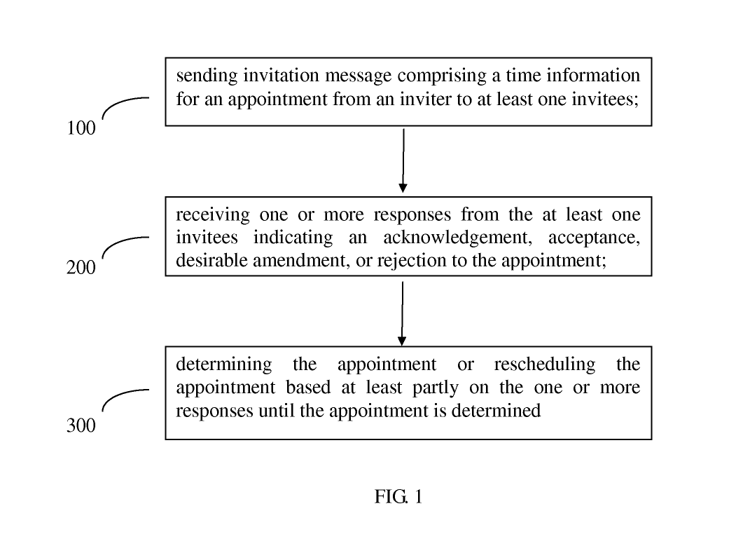

According to the first aspect of the present invention shown in FIG. 1, which relates to an appointment invitation method comprising the steps of: sending via a messaging module an invitation message comprising a time information, as well as an optional attendee information and/or an optional location information, for an appointment from an inviter to at least one invitees selected from a database 100; receiving via the messaging module one or more responses from the at least one invitees indicating an acknowledgement, acceptance, desirable amendment, or rejection to the appointment 200; and determining the appointment or negotiating/rescheduling the appointment based at least partly on the one or more responses received from the at least one invitees until the appointment is determined 300.

According to one preferred embodiment of the present invention, the invitation method is implemented by and based on a mobile application run on a device capable of real-time communications, such as a smartphone, a tablet computer/computing device, a notebook/netbook, a desktop PC, or the like. The present embodiment provides similar functions of conventional calendar applications, such as Google Calendar, Microsoft Outlook Calendar, iCal, or the like, and likewisely requires the use of highly secured programming modules and servers. A user registration is required for mandatory input of at least an alias/nickname (for display purpose), and a mobile phone number, as well as other optional data, such as a real name, an address, an ID number, email addresses (work/personal), a telephone number, an area/postal code and country (for display purpose), or any other specific data enabling establishment of an external direct communication with other people.

Just like an ordinary calendar application, the present embodiment could records daily tasks and appointments with notifications which can only be used and seen by the user. According to the present embodiment, the invitation message might be preferably sent from the user/inviter via a messaging module to friends/invitees through mobile phone numbers selected from a database (e.g. Contacts/phonebook stored in the mobile phone or SIM card). According to the embodiments of the present invention, sending invitation through mobile phone number is the most preferred approach as it could overcome defects of other approaches. For example, using email might be a relatively inconvenient way to handle appointment negotiation as the main usage of the email is mostly related to work. In addition, the user might have non-daily stakeholders or even friends that the user does not register their email, but only record their phone number in the database of the user. In this regard, sending invitation through mobile numbers could integrate the work/life schedules by truly pinpointing usage behavior of the user. Alternatively, the appointment invitation method could be carried out through website or any computing device preferably capable of real time communication.

Preferably, the messaging module provides an user interface for selecting and editing various elements of the message, which could comprise: invitee(s) (one or more entries of the Contacts of the mobile phone), one or more proposed time, as well as optional attendee(s), location, and/or topic/task information for the appointment, and a small extra text-box for simple messaging; wherein most frequently used or lastly selected/edited entries for each of the foregoing elements could be preferably available, viewable, or selectable via various means, such as drop-down bar, list-box, edit box with auto complete feature, or the like.

According to the present embodiment, the user sends invitation message through the mobile phone number to one or more invitees. If the invitee has already acquired and installed the application, the invitation message could be instantly sent with the following preset options for each of the invitees to indicate an acknowledgement, acceptance, desirable amendment, or rejection to the appointment. Preferably, one or more of the options might merely be available to some of the invitees by assigning an attribute to different invitees while sending the message, just like one could classify and enter the email address of different recipients into “to”, “c.c.” and “b.c.c.” fields of an email application, such that the appointment could only be rescheduled by one or more preset attendees while others will be kept informed of changes and the latest status thereof.

If one or more of the invitees set forth one or more desirable amendments, which might relate to the time or even the optional attendee or location for the appointment, then each of the attendees including the inviter and one or more of the invitees might send further amended invitation message to and receiving one or more responses from each other until the appointment is accepted by the inviter and at least one of the invitees and/or the appointment is accepted by at least two of the invitees in case the inviter in fact does not intend to attend the appointment and merely wants to serve as a middle man therebetween.

The provision of the option for desirable amendment allows the proposal and adoption of another time for the appointment as it is not uncommon for an invitee to decline an invitation due to clash on calendar, and it would require the inviter to “re-send” another invitation with newly reproposed time for re-scheduling but the reproposed time may still not be acceptable to the invitee. Thus, it is desirable for the invitee to counter-propose a time that would be best fit to expedite the re-scheduling process.

According to the present embodiment, the invitee might be required to input 1-3 free time slot to indicate the desirable amendment to the appointment and send back a message to the inviter to start an on-going process for both parties upon aligning a date. In this way, this feature would improve the process of selecting the appointment time/date and confirming the appointment by reducing time usage wasted on sending and resending multiple invitations without knowing the invitee's best time slot, which case occurs too often in the prior art.

If an invitee does not have the application, the invitation message will be converted into an invitation notice comprising a basic information for the appointment and a link for acquiring the application and sending it via a messaging protocol from the inviter to the invitee. The notice might be preferably sent by SMS, MMS, or push notifications, or a combination thereof, for delivering real-time communication. The context of the notice might read: “Hi, Your friend, xxx (the alias of the inviter), sent you an appointment in Circler (the name of the application) to you! You can download Circler to accept the invitation!”, and a download link is preferably followed therein.

The user or invitee could preset the application to accept automatically certain friends' invitation (e.g. friends selected from a favorite list of the application), or reject automatically certain people (e.g. people selected from a black list thereof).

According to the embodiment of present invention, the inviter will receive an instant notice when the invitee accepts the invitation, and the appointment would be immediately recorded within both parties' application.

If the invitee selects the option for making desirable amendment to the time for the appointment, 1-3 (or up to 5 or even to 10) another free time slots are required to be inputted or a predetermined alternative time slot could be selected by the invitee and sent back to the inviter, and the process is on-going for both parties upon aligning a specific time slot and date. Likewisely, the inviter will receive an instant notice, and the appointment would be immediately recorded within both parties' application.

According to another preferred embodiment of present invention, the appointment would be stored in an embedded or native calendar system of the application by inserting the determined appointment thereinto. Preferably, the data for the determined appointment of the native calendar system will further be exported and stored into one or more conventional calendar systems comprising MS Outlook Calendar, Apple iCal, Google Calendar, or a combination thereof.

According to the embodiment of present invention, the inviter will receive a rejection notice and the message will be automatically removed from the record of the application, and preferably, such invitation message could be recorded in a rejected log for later reference, in case the invitee selects the option for rejection.

If the invitee merely wants to acknowledge the receipt of the message, the invitee can select the option for acknowledgement to inform the inviter that the status is pending and the invitee maybe accept or reject later the invitation, and then the message will be automatically log within the application (e.g. such invitation message could be recorded in a pending log for later reference), and no intermediate/further notice will be sent to both parties until either one accepts or rejects the invitation, or the invitation expires (e.g. the scheduled appointment time has been passed).

According to the embodiments of the present invention, all complete or incomplete records or tasks could be modified and deleted, and the invitation could be re-sent and the details of which could be amended when necessary.

According to another preferred embodiment of the present invention, the method further comprises a step of reminding the relevant attendees of the appointment by sending an advanced reminding notification or pop-up banner in a specified time period before the appointment. The specified time period is preset by the user to ensure the reminder could be sent once or repeatedly at the right moment, e.g. 1 hour/day ahead of time; and preferably, the reminder could be sent up to 3 days ahead of time. In addition, the reminding notification or pop-up banner allows the receiver to confirm or re-schedule the appointment. In the latter case, all parties of the appointment will receive a re-schedule notification and a new invitation process might be started therefrom.

According to a further preferred embodiment of the present invention, the invitation message sent from the inviter differs from the prior art in that it comprises merely the time information for an appointment without informing the invitees any information related to the attendee and/or the location of the appointment. The invitation message serves as a sort of “I am free” announcement to inform the at least one invitees that the inviter is free and available for accepting and establishing an appointment. The current approach is advantageous as there are occasions where you are free and would like to make better use of that available time but finding people for those occasions might be relatively quite time-consuming. Instead of seeking for people, the present embodiment reverses the procedure of finding people for gathering or appointment by sending invitation message to different preselected parties to inform them the available date and timeslot for appointment. Preferably, the invitation might provide 1-3 selectable options for the available timeslot to increase the chance of establishing an appointment with at least one of the invitees. After determining the time—the essential element—for the appointment, the inviter and/or the invitees might send another message or via other means (e.g. by phone, email, SMS, etc.) to negotiate further the location and/or the list of attendees for the appointment. According to the present embodiment, it should be noted that the location and/or the attendees are regarded as optional but not essential elements for the appointment as an appointment or meeting might be established remotely via various devices capable of real-time communications, In addition, the final attendees for the appointment might exclude the initial inviter and/or the invitee by whom the appointment is arranged and determined, as will be elaborated later.

According to still another preferred embodiment of the present invention, the invitation message might be used to serve as an arrival notice in related to the appointment. For example, when you are going on a date, it is normal to inform your traveling status to whom you are meeting to make better amendments—but some places may not be convenient for a phone call, this function would be a quick and simple way to notify everyone. According to the embodiment, near upon the appointment time, both parties will pop up a reminder to enquire whether you have arrived at your destination. A simple pop-up or message could be sent out to inform your status, and the message might comprise an viewable option for displaying the current status of the sender, such as “Arrived”, “On my way” (preferably with additional indication showing how many minutes upon arrival), a simple textbox for message, and another viewable option for indicating that the user is busy and will update the traveling status later. It should be noted that the foregoing message will be a kind of invitation message comprising merely the time information (how many minutes upon arrival) but no attendee and location information as the latter two information are predetermined and well known by all the attendees of the appointment. Afterwards, the counterpart will receive the pop-up or message and act accordingly. According to the embodiment, the application could be configured and preset to enable the user to disable such feature, and then the user will not receive any reminder and does not need to reply the enquiry from others near upon the appointment time. Alternatively, the reminder or message could be received normally and an automatic reply or response will be issued to indicate that the user is busy and will update the traveling status later. In this way, it could help user to make better arrangements for the relevant appointment.

Presently, an appointment or meeting might involve people domiciled in different regions/countries and attendees of the appointment might travel from one time zone to another time zone. Arranging invitation across different time zone may cause confusion as the receiving parties of the invitation message will receive the local appointment time of the sending party whereby causing confusion among attendees.

According to yet still another preferred embodiment, the invitation method further comprises the steps of acquiring a position information, such as geographical and/or time zone position information, of the inviter and the at least one invitees; and adjusting the time information of the appointment based on the position information while transferring the message and the response therefor, whereby reducing and avoiding the confusion as caused by prior art invitation method. For example, the inviter might send an invitation from Hong Kong for Friday 9 pm to an invitee located in London. After automatic time conversion by the relevant module or means provided by the present invention, the invitee will receive the adjusted appointment time as London Time Zone Friday 1 pm. The position information, such as geographical and/or time zone position information, might be inputted by the user or acquired from the mobile phone or the device on which the invitation application or system of the present invention is run, and/or from an optional internal or external positioning module based on BeiDou/COMPASS, Galileo, GLONASS, GPS or the like. Preferably, the time zone difference is automatically adjusted or compensated while transferring the messages or response for the appointment. Further, the time information might be color coded to indicate whether the time is in a raw format or a modified format. For example, the raw and unmodified time might be in black while the modified time might be in red or other color to avoid confusion among the attendees. Similarly, this feature and other features as set forth herein, such as the time adjustment feature, could be enabled or disabled in a predetermined or preconfigured manner.

Establishing an appointment between multiple parties may be difficult especially when parties are unknown to each other. In addition, it is also desirable to have a technical solution for enabling a user acting as a middle man to bridge together and/or establish an appointment between different parties without exchanging or disclosing first the personal and/or confidential particulars of each of the targeted attendees, as this would surely and greatly simplify secretarial work and reduces the complexity of arranging invitations to parties that have not met prior to the appointment. For example, if a first party and a second party both only know a third party, and the third party would like to aid the first and second parties to arrange an appointment without disclosing or exchanging first their phone numbers to each other; and the third party also does not attend the appointment and just want to be informed on this event, then an inventive invitation mechanism different from the prior art is needed for realizing the foregoing object.

In this regard, one preferred embodiment of the present invention provides an inventive third party invitation mechanism based on the employment of Contacts of mobile phone in which merely the alias of each of the targeted attendees is used. The inventive third party invitation mechanism employs similar invitation procedures as disclosed hereinbefore for establishing the appointment except that the attendee information of the invitation message comprises merely an alias without indication of specific personal particulars of each of the invitees to prevent establishment of a direct communication between the invitees. After confirmation of the appointment, the specific personal particulars comprising a real name, an address, an ID number, an email address, a phone number, or a combination thereof, might then be selectively disclosed to the relevant invitees and/or the final/real attendees represented by the respective invitees.

According to the embodiments of the present invention, the step of determining the appointment comprising the step of determining whether the appointment is accepted by the inviter and at least one of the invitees and/or by at least two of the invitees based at least partly on the one or more responses. In normal cases, the proposed appointment is determined after it has been mutually agreed and accepted by the inviter and at least one of the invitees, a specific number of invitees, or one or more specific invitees desired or predetermined by the inviter. It depends on the initial intention of the inviter who initiated and proposed the appointment. For example, the invitation might be sent to multiple invitees among which merely one or two might be the targeted persons as predetermined by the inviter such that the response from other invitees are irrelevant to the inviter. In addition, it is not necessary to require the acceptance of all of the invitees and the inviter could determine and confirm the appointment once the invitation are accepted by the specific number of invitees or by one or more specific invitees desired or predetermined by the inviter. In case of serving as a third party invitation mechanism, the appointment might be determined once it has been mutually agreed and accepted by at least two of the invitees.

According to the second aspect of the present invention, there is provided an appointment invitation system comprising:

means for sending via a messaging module an invitation message comprising a time information, as well as an optional attendee information and/or an optional location information, for an appointment from an inviter to at least one invitees selected from a database;
means for receiving via the messaging module one or more responses from the at least one invitees indicating an acknowledgement, acceptance, desirable amendment, or rejection to the appointment; and
means for determining the appointment or negotiating/rescheduling the appointment based at least partly on the one or more responses received from the at least one invitees until the appointment is determined;
means for interchanging the time information based on geographical and/or time zone position information of the inviter and the at least one invitees while transferring the message and the response; and
means for enabling appointment negotiation via the messaging module but preventing establishment of an external direct communication between the invitees while rescheduling the appointment; and
means for implementing each of the foregoing features/steps of the appointment invitation method as set forth hereinbefore.

According to the third aspect of the present invention, the invitation method set forth hereinbefore can be implemented by a program and a computing device, wherein the program might be stored in a conventional storage medium or device well known in the art. The program may be accessed, executed, transferred over a network while the data and messages generated during execution are temporarily or permanently stored in volatile memory or nonvolatile memory of the computing device for later reference or further processing. According to one preferred embodiment, which provides a program embedded on a medium when executed by a computing device for causing the computing device to perform a processing for invitation of an appointment, the program comprising:

sending via a messaging module an invitation message comprising a time information, as well as an optional attendee information and/or an optional location information, for an appointment from an inviter to at least one invitees selected from a database;
receiving via the messaging module one or more responses from the at least one invitees indicating an acknowledgement, acceptance, desirable amendment, or rejection to the appointment; and
determining the appointment or negotiating/rescheduling the appointment based at least partly on the one or more responses received from the at least one invitees until the appointment is determined; and
wherein the program further comprising interchanging the time information based on geographical and/or time zone position information of the inviter and the at least one invitees while transferring the message and the response; and enabling appointment negotiation via the messaging module but preventing establishment of an external direct communication between the invitees while rescheduling the appointment.

Preferably, the program comprises various components, functions, and procedures for implementing each of the foregoing features/steps of the appointment invitation method as set forth hereinbefore

The preferred embodiments of the present invention have been described above in details with reference to the accompanied drawings, though it will be apparent to those skilled in the art that some features that are not particularly important to the understanding of the present invention may not be described or shown in the accompanied drawings for the sake of clarity.

In addition, it should also be understood that the invitation method, system and program as described in the present application is not limited to the specific embodiments described above and that various alterations and modifications may be made thereto by those skilled in the art without departing from the teachings or scope of the present application. For example, steps, elements and/or features of various exemplary or illustrative embodiments may be combined with each other and/or substituted for each other within the scope of the present application, which shall all fall into the scope of the present invention.

What is claimed is:

1. An appointment invitation method comprising:
sending via a messaging module an invitation message comprising a time information indicating a target time and/or one or more preset target time alternatives for holding an appointment from an inviter to at least one invitees;
receiving via the messaging module one or more responses indicating an acknowledgement, acceptance, desirable amendment, or rejection to the appointment from the at least one invitees; and
determining the appointment or negotiating/rescheduling the appointment based at least partly on the one or more responses received from the at least one invitees until the appointment is determined;
wherein the invitation message further comprise an attendee information and/or an location information being optional to the invitation message such that determination of the appointment is independent of either one or both.

2. The invitation method of claim 1, further comprising:
updating native calendar system of the messaging module by inserting the determined appointment thereinto.

3. The invitation method of claim 2, further comprising:
exporting data for the determined appointment of the native calendar system into conventional calendar systems.

4. The invitation method of claim 1, further comprising:
acquiring position information of the inviter and the at least one invitees; and
adjusting the time information based on the position information while transferring the message and the response.

5. The invitation method of claim 1, further comprising:
acquiring geographical and/or time zone position information of the inviter and the at least one invitees; and
adjusting the time information based on the geographical or time zone position information while transferring the message and the response.

6. The invitation method of claim 5, wherein acquiring geographical and/or time zone position information comprising receiving the geographical and/or time zone position information provided manually by the inviter and the at least one invitees; and/or acquiring automatically the geographical and/or time zone position information by an internal or external positioning module based on BeiDou/Compass, Galileo, GLONASS, GPS, or a combination thereof.

7. The invitation method of claim 1, wherein rescheduling the appointment comprising:
responsive to the desirable amendment, sending one or more amended invitation message to and receiving one or more responses from the at least one invitees until the appointment is accepted by the inviter and at least one of the invitees and/or by at least two of the invitees.

8. The invitation method of claim 1, wherein the attendee information comprises an alias without indication of specific personal particulars of each of the inviter and at least one of the invitees to prevent establishment of a direct communication between the invitees.

9. The invitation method of claim 1, wherein the attendee information comprises an alias without indication of specific personal particulars of each of at least two of the invitees to prevent establishment of an external direct communication therebetween.

10. The invitation method of claim 8, wherein the specific personal particulars comprise a real name, an address, an ID number, an email address, a phone number, or a specific data enabling establishment of an external direct communication therebetween.

11. The invitation method of claim 9, wherein the specific personal particulars comprise a real name, an address, an ID number, an email address, a phone number, or a specific data enabling establishment of an external direct communication therebetween.

12. The invitation method of claim 1, wherein determining the appointment comprising:
determining whether the appointment is accepted by the inviter and at least one of the invitees and/or by at least two of the invitees based at least partly on the one or more responses.

13. The invitation method of claim 1, further comprising:
converting the invitation message into an invitation notice comprising a basic information for the appointment and a link for acquiring the messaging module and sending it via a messaging protocol from the inviter to the at least one invitees who had not acquired the messaging module.

14. The invitation method of claim 13, wherein the messaging protocol is at least one of SMS, MMS, or push notifications for delivering real-time communication.

15. The invitation method of claim 1, wherein:
the invitation message further comprise the attendee information indicating one or more target attendees for the appointment based on which the appointment is at least partially determined, and the inviter and/or the at least one invitees could be included in or excluded from the target attendees.

16. The invitation method of claim 15, wherein:
the one or more target attendees do not know each other and/or do not acquire any specific contact information enabling establishment of a direct communication between each other prior to the appointment.

17. The invitation method of claim 1, wherein:
the invitation message further comprise the location information indicating a target location for the appointment based on which the time information is automatically adjusted and displayed while transferring the message and the response.

18. The invitation method of claim 17, wherein:
the time information is adjusted at least partially based on determination of whether the inviter and/or the at least one invitees are domiciled and/or located in different time zones from the target location for the appointment.

19. An appointment invitation system, comprising:
means for sending via a messaging module an invitation message comprising a time information, as well as an optional attendee information and/or an optional location information, for an appointment from an inviter to at least one invitees;
means for receiving via the messaging module one or more responses from the at least one invitees indicating an acknowledgement, acceptance, desirable amendment, or rejection to the appointment; and
means for determining the appointment or negotiating/rescheduling the appointment based at least partly on the one or more responses received from the at least one invitees until the appointment is determined.

20. A program embedded on a medium when executed by a computing device for causing the computing device to perform a processing for invitation of an appointment, comprising:
sending via a messaging module an invitation message comprising a time information, as well as an optional attendee information and/or an optional location information, for an appointment from an inviter to at least one invitees;
receiving via the messaging module one or more responses from the at least one invitees indicating an acknowledgement, acceptance, desirable amendment, or rejection to the appointment; and
determining the appointment or negotiating/rescheduling the appointment based at least partly on the one or more responses received from the at least one invitees until the appointment is determined.
